(19) United States
(12) Patent Application Publication
(10) Pub. No.: US 2008/0009296 A1
(43) Pub. Date: Jan. 10, 2008

(54) Systems and Methods for Remotely Enabling and Disabling Non-Voice-Related Functions on Portable Communication Devices

(76) Inventor: Sam S. Han, Marietta, GA (US)

Correspondence Address: Sam S. Han, 330 Bloombridge Way, Marietta, GA, 30066, US

(21) Appl. No.: 11/456,439

(22) Filed: Jul. 10, 2006

(51) Int. Cl. H04Q 7/20

(52) U.S. Cl. 455/456.4

(57) ABSTRACT

Systems and methods for remotely enabling and disabling non-voice-related functions on portable communication devices are disclosed. Some embodiments include a portable communication device that is capable of notification functions, voice-related functions, and non-voice-related functions. The portable communication device comprises a receiver and a software switch. The receiver is configured to receive an externally-originating signal, and the software switch is configured to substantially disable a non-voice-related function of the portable communication device in response to the externally-originating signal.

### FIELD OF THE DISCLOSURE

The present disclosure relates generally to portable communications devices and, more particularly, to systems and methods for remotely enabling or disabling non-voice-related functions on portable communication devices.

### BACKGROUND

It is well known that one of the major hazards for operators of motor vehicles is distraction. Many things can distract driver, including changing radio stations while driving, eating or drinking while driving, or talking on a cellular telephone while driving. In an effort to reduce such hazards, the industry has attempted various measures to mitigate such distractions. Despite such efforts, there still exists a need for further measures to reduce driver distraction.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of a conventional personal digital assistant (PDA) communication device.

FIG. 2 is a diagram of a conventional cellular telephone, showing various components within the cellular telephone.

FIG. 3 is a diagram of a portable communication device, in accordance with one embodiment of the invention.

FIG. 4 is a diagram of another portable communication device, in accordance with another embodiment of the invention.

FIG. 5 is a flowchart showing one embodiment of a process performed by a portable communication device.

FIG. 6 is a flowchart showing another embodiment of a process performed by a portable communication device.

FIG. 7 is a flowchart showing yet another embodiment of a process, in which a signal is transmitted in order to disable a non-voice-related function in a portable communication device.

### DEFINITIONS

Unless otherwise limited or modified, the following definitions shall apply throughout this disclosure.

“Or” shall broadly be construed as and/or.

“And” shall broadly be construed as and/or.

“Signal” shall include both digital and analog signals. Examples of signals include, but are not limited to, data packets, sound waves, infrared signals, and any other emission that is encompassed within the electromagnetic spectrum.

“Portable communication device” shall mean any device that is portable, and which can be configured to transmit or receive signals. Examples of portable communication devices include, but are not limited to, cellular telephones, personal digital assistants, satellite telephones, portable computers, removable wireless cards, currently-known and future-developed devices that are capable of communicating over the Internet, currently-known and future-developed devices that are capable of wireless communications (e.g., Bluetooth®-enabled devices, infrared-enabled devices, Wi-Fi®-enabled devices, etc.), any other device that permits a user to transmit or receive one or more signals, and equivalents of such devices.

“Voice-related function” shall mean a communication function that is related to audible sound waves. Voice-related functions shall include talking, listening, voice-activation of portable communications devices, and voice-deactivation of portable communications devices.

“Notification function” shall mean a function that is used to notify a user.

Notification functions shall include ringing sounds, vibrations, blinking lights, or other known or future-developed methods of notifying a user of an event. Example events for which a user may be notified include, but are not limited to, incoming telephone calls, incoming email messages, incoming instant messages, alarms, calendar items, reminder items, low-battery indicators, and other events associated with a portable communication device.

“Visual function” shall mean a function that requires visual interaction. Examples of visual functions include, but are not limited to, viewing email messages, viewing text messages, dialing a telephone number, sending text messages, receiving text messages, sending email messages, receiving email messages, sending near-real-time instant messages, receiving near-real-time instant messages, accessing the Internet, word processing, data input, data access, data processing, and equivalents of such functions.

“Non-voice-related function” shall mean any function that is neither a voice-related function nor a notification function. Examples of non-voice-related functions include, but are not limited to, sending text messages, receiving text messages, sending email messages, receiving email messages, sending near-real-time instant messages, receiving near-real-time instant messages, accessing the Internet, word processing, data input, data access, data processing, and equivalents of such functions. Some non-voice-related functions overlap with visual functions.

“Hardware switch” shall mean a physical mechanism for substantially enabling, substantially disabling, or substantially altering at least one function of a device. Examples of a hardware switch include, but are not limited to, an “on” button, an “off” button, a toggle switch capable of turning a device on or off, selection buttons for selecting one or more functions of a device, trackballs, track wheels, mouse, pointer, and equivalents of such mechanisms.

“Software switch” shall mean any mechanism, other than a hardware switch, for substantially enabling, substantially disabling, or substantially altering at least one function of a device.

“Externally-originating signal” shall mean any signal that originates from an electronic signal source that operates external to a portable communication device.

“Conventional communication device” shall mean any device, which was in existence prior to the filing date of this application, and which is configured to transmit or receive signals.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

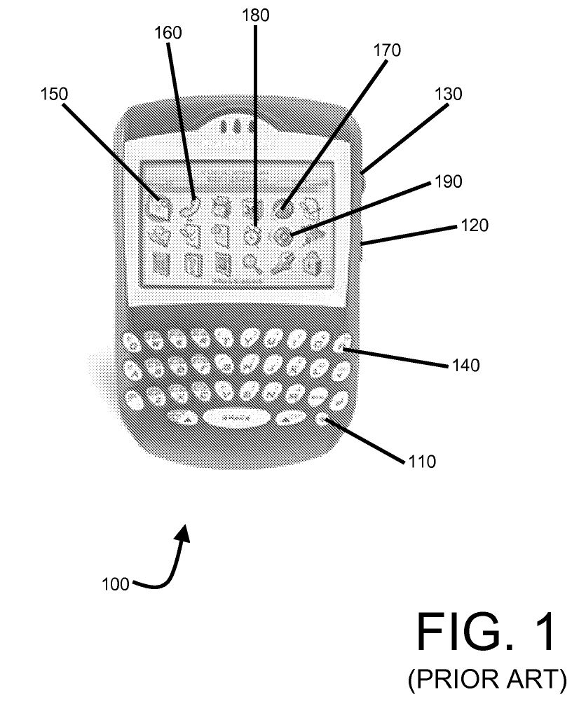

Turning now to the drawings, FIG. 1 is a diagram of a personal digital assistant (PDA) communication device 100. Specifically, FIG. 1 shows a BlackBerry® handheld device 100 (“BlackBerry”), which is a conventional communication device that can be found in the prior art. The BlackBerry 100 includes an on/off hardware switch 110, which permits a user to turn the BlackBerry 100 on and off. In addition to the hardware switch 110, the BlackBerry 100 also includes a trackwheel 130, which can be used to select various functions of the BlackBerry 100. Examples of available functions are email functions 150 (sending and receiving email messages), phone functions 160 (making cellular telephone calls), Internet-browsing functions 170, and alarm functions 180. The BlackBerry 100 permits a user to change the volume levels 190 of various ring tones through known scrolling mechanisms, which can be accessed by the trackwheel 130. In terms of hardware switches 110, the BlackBerry 100 also includes an escape key 120. Since the various functions of the BlackBerry 100 are known in the art, further discussion of the conventional PDA-type communication device is omitted here.

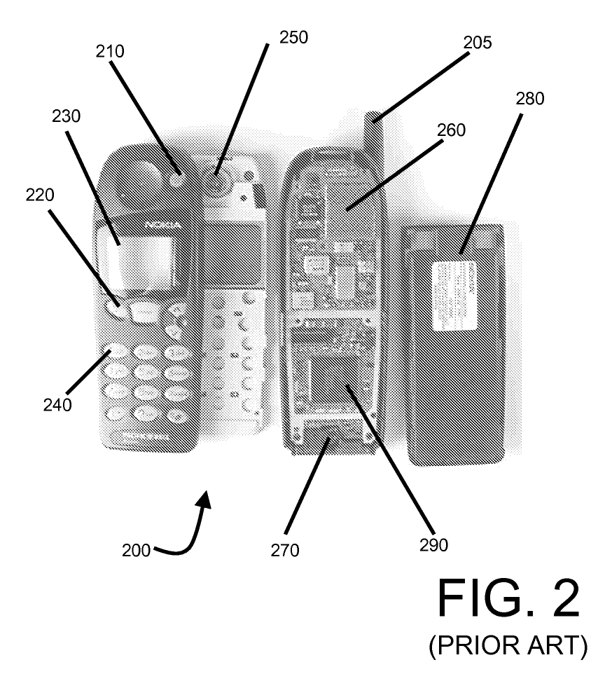

FIG. 2 is a diagram of a cellular telephone 200, which is another example of a conventional communication device. Specifically, FIG. 2 shows various components within the cellular telephone 200. As shown in FIG. 2, the cellular telephone 200 includes a battery 280, which provides the power to the cellular telephone 200. Externally accessible to the user, the cellular telephone 200 has a hardware on/off switch 210, a keypad 240, function selection keys 220, an antenna 205, and a screen 230 (typically liquid crystal display (LCD)) for displaying information to the user.

Some cellular telephones 200 also include a digital camera 250 that permits picture-taking by a user. Internal to the cellular telephone 200, one can find a speaker 260 that produces audible sounds, such as, for example, ring tones or voice from an incoming telephone call. The cellular telephone 200 also includes a microphone 270 that captures the user's voice during an outgoing telephone call. Since such conventional cellular telephones 200 are ubiquitous and well known, further discussion of conventional cellular telephones is omitted here.

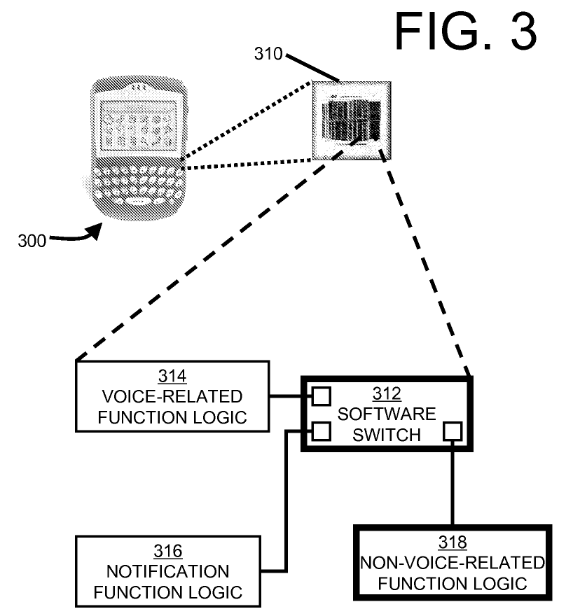

FIG. 3 is a diagram of a portable communication device (PCD) 300, in accordance with one embodiment of the invention. Unlike the conventional BlackBerry 100 of FIG. 1, the PCD 300 of FIG. 3 is configured to selectively disable and enable non-voice-related functions.

As such, the PCD 300 includes a microprocessor 310 with a software switch 312. The software switch 312 is operatively coupled to voice-related function logic 314, notification function logic 316, and non-voice-related function logic 318. The notification function logic 316 is configured to control one or more of the notification functions of the PCD 300, which convey to the user that an event (e.g., incoming telephone call, alarm, low battery, etc.) has occurred. Since notification functions and their implementation are known in the art, only a truncated discussion of notification functions is provided here.

The voice-related function logic 314 is configured to control one or more of the voice-related functions of the PCD 300. These functions primarily deal with outgoing telephone calls, incoming telephone calls, and other functions that can be accessed by audible cues. For example, on a PCD 300 that is equipped with voice or speech recognition, the voice-related function logic 314 may also control those voice or speech recognition functions.

The non-voice-related function logic 318 is configured to control one or more of the other functions that are neither voice-related functions nor notification functions. These non-voice-related functions include sending and receiving text messages, sending and receiving email messages, sending and receiving instant messages, accessing the Internet, and other similar functions.

In operation, the PCD 300 receives an externally-originating signal through its receiver (e.g., antenna and conventional receiver logic). The externally-originating signal carries a predefined code that instructs the PCD 300 to disable at least one of its non-voice-related functions. The software switch 312, which is configured to respond to the externally-originating signal, receives the externally-originating signal and conveys a disable command to the non-voice-related function logic 318. The non-voice-related function logic 318, upon receiving the disable command, disables the non-voice-related function.

For some embodiments, the externally-originating signal may be a Bluetooth®-compatible signal. Thus, if the external source is a Bluetooth®-enabled car, then the Bluetooth® components of the car may generate and transmit the disable command to the PCD 300. As such, when a driver enters the car with the PCD 300, one or more of the non-voice-related functions of the PCD 300 can be disabled, thereby reducing the number of distractions that a driver may encounter while driving.

For some embodiments, the disable command only disables one non-voice-related function on the PCD 300, such as sending an email message, while not disabling other non-voice-related functions on the PCD 300, such as receiving an email message. For yet other embodiments, all of the non-voice-related functions on the PCD 300 may be disabled. As one can see, various permutations of the non-voice-related functions can be disabled, depending on the tolerable level of distraction. Specifically, if the state or federal legislature enacts a law that prohibits text messaging while driving, then the text-messaging feature of the PCD 300 can be disabled remotely by a Bluetooth®-compatible car.

The disable command may also originate from other external sources, such as towers or stations that are located in close proximity to busy intersections. Thus, when a driver approaches a relatively-treacherous intersection, such towers or stations can disable the non-voice-related functions of the PCD 300, thereby reducing the distractions to the driver.

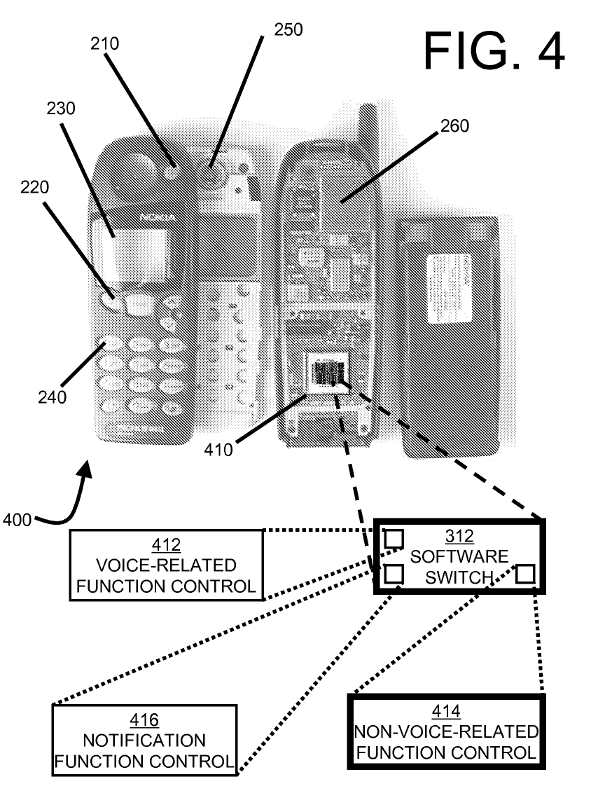

FIG. 4 is a diagram of another PCD 400, in accordance with another embodiment of the invention. Specifically, FIG. 4 shows a cellular telephone embodiment of a PCD 400.

The PCD 400 also includes a microprocessor 410 with a software switch 312. The software switch 312, shown in greater detail here, includes several control blocks. Relevant control blocks include the voice-related function control 412, the notification function control 416, and the non-voice-related function control 416. The voice-related function control 412 is configured to control the voice-related function logic 314 (FIG. 3). Similarly, the notification function control 416 is configured to control the notification function logic 316 (FIG. 3), and the non-voice-related function control 414 is configured to control the non-voice-related function logic 318 (FIG. 3).

Thus, in operation, when the PCD 400 receives an externally-originating signal, the software switch 312 receives that signal and, through its non-voice-related function control 414, generates a disable command. That disable command is conveyed to the non-voice-related function logic 318 (FIG. 3), which then disables one or more non-voice-related functions.

For some embodiments, the software switch 312 is configured to disable the non-voice-related function without disabling the voice-related functions of the PCD 300, 400.

For other embodiments, the software switch 312 is configured to disable a notification function that corresponds to the disabled non-voice-related function. For yet other embodiments, the software switch 312 is configured to disable the non-voice-related function without disabling any of the voice-related functions or the notification functions of the PCD 300, 400.

As one can see, the disabling of one or more non-voice-related functions provides less distractions from the PCD 300, 400.

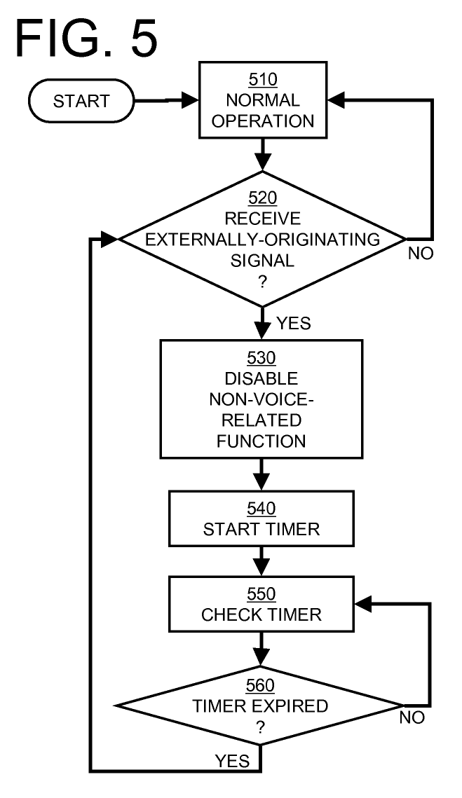

While some of the operations of the PCD 300, 400 are described with reference to FIGS. 3 and 4, other embodiments showing methods of disabling non-voice-related functions on PCD 300, 400 are shown with reference to FIGS. 5 through 7.

FIG. 5 is a flowchart showing one embodiment of a process performed by a PCD 300, 400. As shown in FIG. 5, one embodiment of the process begins (510) with the normal operation of the PCD 300, 400. The PCD 300, 400 determines whether or not it received (520) an externally-originating signal for disabling a non-voice-related function on the PCD 300, 400. If the PCD 300, 400 did not receive (520) such an externally-originating signal, then the PCD 300, 400 continues to operate normally (510).

Alternatively, if the PCD 300, 400 receives (520) an externally-originating signal for disabling a non-voice-related function on the PCD 300, 400, then the PCD 300, 400 disables the non-voice-related function in response to receiving the signal. Since the components of the PCD 300, 400, which control the enabling and disabling of the non-voice-related functions, are described with reference to FIGS. 3 and 4, further discussion of those components is omitted here.

Once the non-voice-related function is disabled (530), a timer within the PCD 300, 400 is started (540) and the microprocessor 310, 410 in the PCD 300, 400 periodically checks (550) the timer to see if a predetermined time interval has expired. When the predetermined time interval expires (560), the PCD 300, 400 again determines whether or not it received (520) an externally-originating signal for disabling the non-voice-related function. If, after the predetermined time interval, the PCD 300, 400 stops receiving the externally-originating signal for disabling the non-voice-related function, then the non-voice-related function is enabled, and the PCD 300, 400 resumes in normal operation (510). Alternatively, if the PCD 300, 400 continues to receive the externally-originating signal for disabling the non-voice-related function, then the non-voice-related function continues to be disabled until the PCD 300, 400 stops receiving the externally-originating signal for disabling the non-voice-related function.

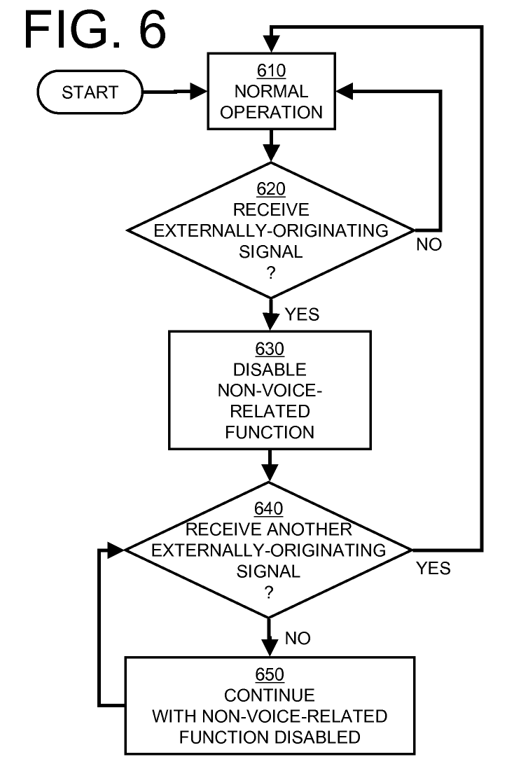

FIG. 6 is a flowchart showing another embodiment of a process performed by a PCD 300, 400. As shown in FIG. 6, the process again begins with normal operation (610). If the PCD 300, 400 does not receive (620) an externally-originating signal that disables a non-voice-related function, then the PCD 300, 400 continues in normal operation (610). Conversely, if the PCD 300, 400 receives (620) an externally-originating signal for disabling a non-voice-related function, then the PCD 300, 400 disables (630) the non-voice-related function. For some embodiments, the disabled non-voice-related function can be specified by the externally-originating signal.

Upon disabling (630) the non-voice-related function, the PCD 300, 400 determines whether or not it has received (640) another externally-originating signal for enabling the non-voice-related function. If such an enabling externally-originating signal has not been received (640), then the PCD 300, 400 continues (650) operating with the non-voice-related function disabled. If, on the other hand, an enabling externally-originating signal is received (640) by the PCD 300, 400, then the PCD 300, 400 enables the previously-disabled non-voice-related function, and continues in normal operation mode (610).

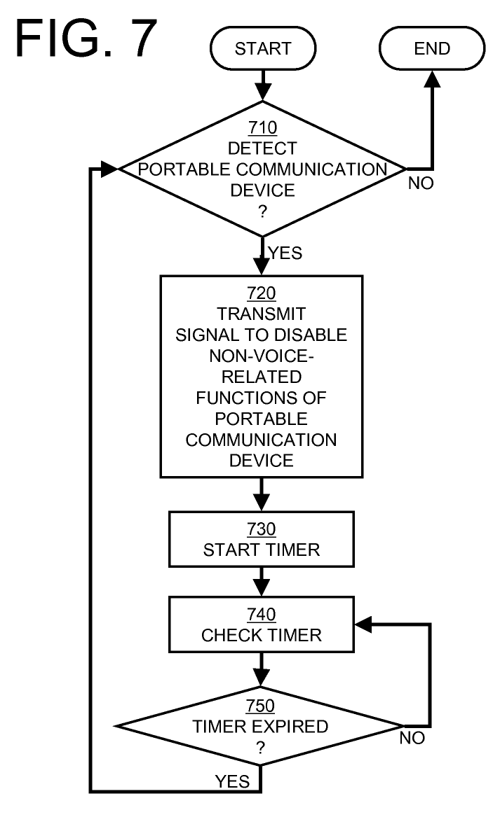

As shown in the embodiments of FIGS. 6 and 7, various non-voice-related functions of a PCD 300, 400 can be remotely disabled for an arbitrary amount of time. Thus, for example, if the user of a Bluetooth®-enabled PCD 300, 400 is driving in a Bluetooth®-enabled car, then, as long as the driver remains within range of the car, the car can disable the PCD 300, 400 by periodically (or continually) transmitting a disable command to the PCD 300, 400 to disable one or more non-voice-related functions of the PCD 300, 400. This permits a driver to operate the vehicle with fewer distractions, thereby making for a safer environment.

FIG. 7 is a flowchart showing yet another embodiment of a process, in which a signal is transmitted in order to disable a non-voice-related function in a PCD 300, 400. As noted above, for some embodiments, the transmitter can be located in a cellular tower near busy intersections or roads. In other alternatives, the transmitter can be located in a Bluetooth®-enabled car. In any event, so long as the transmitter is located external to the PCD 300, 400, the non-voice-related functions can be considered to be remotely controlled.

Using a Bluetooth®-enabled car, for example, one embodiment of the process begins when the car detects (710) the PCD 300, 400. Upon detection, the car and the PCD 300, 400 engage in a synchronization process, or a handshake process, to establish communications between the car and the PCD 300, 400. Since such handshake procedures are well-established protocols for Bluetooth®, further discussion of handshake procedures is omitted here.

Upon completing the handshake procedure, the Bluetooth® components of the car transmits (720) a signal to disable one or more non-voice-related functions of the PCD 300, 400. For the embodiment of FIG. 7, the Bluetooth®-enabled car starts (730) a timer for a predetermined time interval, and periodically checks (740) the timer to see if the predetermined time interval has expired. When the time interval has expired (750), the Bluetooth®-enabled car determines whether the PCD 300, 400 is still detectable (710). If the PCD 300, 400 is no longer within range, then the Bluetooth®-enabled car stops transmitting the signal. Alternatively, if the PCD 300, 400 is still within range and detectable (710) by the Bluetooth®-enabled car, then the Bluetooth® components continue to transmit the signal to disable the non-voice-related functions.

Having such control features in a car can reduce the distractions that are normally present with cellular telephones and hand-held devices. Specifically, talking on a cellular telephone may not be a large distraction, since it is possible to visually focus on the road while talking. However, typing messages or visually browsing the Internet is a monumental hazard since it is virtually impossible to visually focus on the road while concurrently visually focusing on the LCD screen of a PCD 300, 400. By having mechanisms for disabling one or more non-voice-related functions, safer driving conditions can be established.

The various embodiments, as disclosed above, are unobvious when compared to the prior art for several reasons. While the prior art teaches the disabling of notification features or the complete disabling of conventional communication devices, none of the prior art teaches a device that remotely disables non-voice-related functions of a personal communication device.

One example of the prior, U.S. Pat. No. 6,970,724, issued to Leung and having the title “Apparatus and Method for Automatically Disabling Cell Phone Ringing” (“Leung”) teaches the disabling of the ring tone on a cellular telephone. Specifically, Leung teaches a method of remotely triggering a feature that is already existent on a cellular telephone. Specifically, it is well known that the ring tone of a cellular telephone can be disabled. Leung simply extends that disabling mechanism to a remote controller. Unlike Leung, the various embodiments of FIGS. 3 through 7 are distinct and unobvious because, to the inventor's knowledge, conventional communication devices do not have a feature, whether remote or local, which permits selective disablement of non-voice-related functions. In other words, unlike Leung, which remotely accesses the components of a cellular telephone that is already in existence, the embodiments of FIGS. 3 through 7 require functionality and components, either software or hardware, that are not currently present in conventional communication devices.

The prior art also teaches the scrambling of a cellular telephone, which wholly disables both the voice-related functions and the non-voice-related functions of a cellular telephone. The embodiments of FIGS. 3 through 7 are unobvious when compared to the scrambling mechanism because, unlike scrambling, the embodiments of FIGS. 3 through 7 permit selective disablement of only the non-voice-related functions, rather than the complete disabling of all communication functions. As such, the embodiments of FIGS. 3 through 7 require software or hardware components that currently do not exist in conventional communication devices.

The prior art also teaches the complete deactivation of conventional communication devices in restricted areas, such as, for example, hospitals, airports, gasoline pumps, or explosive blasting sites. The complete deactivation mechanism, which is taught in the prior art, activates a software switch that completely shuts off the conventional communication device. In other words, the complete deactivation simply accesses a software component that is already existent in conventional communication devices, the only difference being that the already-existing components are now being remotely accessed. Unlike these complete deactivation devices, the embodiments of FIGS. 3 through 7 require software or hardware that currently does not exist in conventional communication devices.

The software switch, and the various components shown in FIGS. 3 and 4, may comprise logic components, which may be implemented in hardware, software, firmware, or a combination thereof. In the preferred embodiment(s), the logic components are implemented in software or firmware that is stored in a memory and that is executed by a suitable instruction execution system. If implemented in hardware, as in an alternative embodiment, the logic components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The software switch, and the other components shown in FIGS. 3 and 4, can be implemented as a program, which comprises an ordered listing of executable instructions for implementing logical functions. As such, the software switch can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the disclosure as described may be made. For example, while Bluetooth® has been described in detail, other wireless mechanisms can be employed to trigger the software switch, such as infrared (IR), Wi-Fi®, spread-spectrum technology, or other currently-existing or future-developed technologies. All such changes, modifications, and alterations should therefore be seen as within the scope of the disclosure.

What is claimed is:

1. In a conventional communication device capable of notification functions, voice-related functions, and non-voice-related functions, the conventional communication device having a software switch, a method wherein the improvement comprises the steps of:
receiving an externally-originating signal; and
disabling a non-voice-related function in response to receiving the externally-originating signal.

2. The device of claim 1, further comprising the step of disabling the non-voice-related function without disabling the voice-related functions.

3. The device of claim 1, further comprising the step of disabling the non-voice-related function without disabling the notification functions.

4. The device of claim 1, further comprising the step of disabling a notification function related to the disabled non-voice-related function.

5. The device of claim 1, wherein the non-voice-related function is a visual function.

6. A system comprising:
a portable communication device capable of voice-related functions, the portable communication device further being capable of notification functions, the portable communication device further being capable of non-voice-related functions;
a receiver operatively coupled to the portable communication device, the receiver being configured to receive an externally-originating signal; and
a software switch operatively coupled to the receiver, the software switch being configured to disable a non-voice-related function of the portable communication device in response to the externally-originating signal.

7. The system of claim 6, wherein the software switch is further configured to disable the non-voice-related function without disabling the voice-related functions.

8. The system of claim 6, wherein the software switch is further configured to disable the non-voice-related function without disabling the notification functions.

9. The system of claim 6, wherein the software switch is further configured to disable a notification function related to the disabled non-voice-related function.

10. The system of claim 6, wherein the software switch comprises means for disabling a notification function related to the disabled non-voice-related function.

11. The system of claim 6, wherein the software switch is further configured to enable the disabled non-voice-related function in response to a different externally-originating signal.

12. The system of claim 6, wherein the software switch is further configured to enable the disabled non-voice-related function after a predetermined time interval.

13. A method comprising the steps of:
receiving an externally-originating signal at a portable communication device, the portable communication device permitting voice-related functions, the portable communication device further permitting non-voice-related functions, the portable communication device further permitting notification functions; and
disabling a non-voice-related function in response to receiving the externally-originating signal.

14. The method of claim 13, further comprising the step of:
enabling the non-voice-related function in response to receiving a different externally-originating signal.

15. The method of claim 13, further comprising the step of:
enabling, after a predetermined period of time period, the non-voice-related function in response to not receiving another externally-originating signal within the predetermined time period.

16. The method of claim 13, wherein the disabling step further comprises the step of disabling the non-voice-related functions without disabling the voice-related functions.

17. The method of claim 13, wherein the disabling step further comprises the step of disabling the non-voice-related functions without disabling the notification functions.

18. The method of claim 13, further comprising the step of disabling a notification function associated with the disabled non-voice-related function.
